(19) United States
(12) Patent Application Publication
(10) Pub. No.: US 2010/0021259 A1
(43) Pub. Date: Jan. 28, 2010

(54) Anchoring Element

(76) Inventors: Pietro Bianchi, Gams (CH); Roger Tognini, Heerbrugg (CH); Bernhard Sander, Munich (DE); Clemens Lutz, Buchs (CH); Joerg Appl, Buchs (CH)

Correspondence Address: ABELMAN, FRAYNE & SCHWAB, 666 THIRD AVENUE, 10TH FLOOR, NEW YORK, NY, 10017, US

(21) Appl. No.: 12/460,886

(22) Filed: Jul. 23, 2009

(30) Foreign Application Priority Data
Jul. 24, 2008 (DE) 10 2008 040 687.2

(51) Int. Cl. F16B 13/06; F16B 13/04

(52) U.S. Cl. 411/54; 411/78

(57) ABSTRACT

An anchoring element for being mounted on a shaft (52) of a fastening element (51) includes a sleeve-shaped base body (13; 33; 63; 73; 83) forming a through-opening (12; 32; 62; 72; 82) for the shaft (52), and anchoring sections (15; 35; 85) projecting outwardly from an outer side of the base body (13) for anchoring on a wall of a borehole (42). Each of the anchoring sections (15; 35; 85) has at least four sides, with one of the sides forming a connection side (89) for connecting a respective anchoring section (15; 35, 85) with the base body (13; 33; 63; 73; 83) and with at least a side located opposite the connection side (89) forming a cleaning side (90) of the respective anchoring section (15; 35; 85). The cleaning side (90) has at least one cleaning edge for cleaning the wall of the borehole (42) during driving of the anchoring element (11; 31; 61; 71; 81) in the borehole (42).

### BACKGROUND OF THE INVENTION

1. Field of the Invention

The present invention relates to an anchoring element mountable on a shaft of a fastening element. The present invention also relates to a fastening assembly anchorable in a borehole of a constructional component with a hardenable mass and having a fastening element and at least one anchoring element, and to a fastening arrangement with such a fastening assembly.

2. Description of the Prior Art

It is known to chemically anchor a fastening element in a borehole with a hardenable mass that is brought into the borehole before or after insertion of the fastening element in the borehole. The fastening element can be formed, e.g., as a threaded rod provided along its entire longitudinal extent with a thread that forms the outer profile. When such a fastening element is chemically anchored, a rupture can occur along a contact region between the shaft and the hardenable mass and/or along a contact region between the borehole wall and the hardenable mass.

Bonding of the hardened mass to the borehole wall and, thus, anchoring of the fastening element in the borehole can be improved by cleaning the borehole and, in particular, by cleaning the borehole wall. Cleaning of the borehole involves additional expenses and requires separate auxiliary means necessary to achieve advantageous results and which are not always available to the user.

German Patent DE 40 10 051 C1 discloses a fastening element anchorable in a borehole with a hardenable mass and having a shaft and a sleeve-shaped cleaning element having openings and connected with the shaft for joint rotation therewith. Upon driving of the fastening element in the borehole, the borehole is cleaned at several locations. Simultaneously, the hardenable mass, which as been brought in the borehole in advance, if needed, is intermixed upon the fastening element being driven in the borehole.

The drawback of the fastening element disclosed in DE 40 10 051 C1 consists in that the fastening element can be loaded only after hardening of the hardenable mass, and the cleaning element must be rotatably driven into the borehole for cleaning the borehole wall. For the necessary connection of the cleaning element with the fastening element for joint rotation therewith, the fastening element must be secured on the shaft with separate means, which is expensive.

U.S. Pat. No. 1,688,087 discloses a fastening element anchorable in a borehole with a hardenable mass and having a shaft with a thread-shaped outer profile and a plurality of flat ring-shaped anchoring elements each having a through-opening for the shaft and an outer diameter greater than a nominal diameter of the borehole in which the fastening element is being anchored. The fastening element is inserted in the borehole as a unitary element, i.e., with anchoring elements being arranged on its shaft. The flat ring-shaped anchoring elements provide for mechanical anchoring of the fastening element in a borehole until the hardenable mass, which is introduced in the borehole before or after the insertion of the fastening element, sufficiently hardens.

The drawback of the fastening element described above consists in that in view of the shaped outer profile of the shaft of the fastening element, the flat ring-shaped anchoring elements easily incline in a plane extending transverse to the longitudinal axis of the shaft and, as a result, the shaft section that projects from the borehole after setting of the fastening element, does not extend perpendicular to the surface of the constructional component. The subsequent adjustment of the shaft generally is possible, if at all, only within certain limits as the adjustment is effected against a counter-force generated by the fastening element.

Further, for cleaning of the borehole wall sufficient for a chemical anchoring and for an adequate anchoring of the fastening element, a sufficient number of anchoring elements should be provided and which are separately mounted on the shaft of the fastening element, which is expensive.

Accordingly, an object of the present invention is to provide an anchoring element that can easily be mounted on a fastening element shaft with a shaped outer profile while insuring that different constrains of the costs of setting of a fastening element are met.

Another object of the present invention is to provide a chemically anchorable fastening assembly with at least one anchoring element.

A further object of the present invention is to provide a fastening arrangement with the inventive fastening assembly and which permits to reduce the setting costs.

### SUMMARY OF THE INVENTION

These and other objects of the present invention, which will become apparent hereinafter, are achieved by providing an anchoring element having a sleeve-shaped base body forming a through-opening for the shaft, and anchoring sections projecting outwardly from an outer side of the base body for anchoring on a wall of a borehole, with each of the anchoring sections having at least four sides, with one of the sides forming a connection side for connecting a respective anchoring section with the base body and with at least a side located opposite the connection side forming a cleaning side of the respective anchoring section and having at least one cleaning edge for cleaning the wall of the borehole during driving of the anchoring element in the borehole.

The anchoring element, the through-opening of which is formed by the sleeve-shaped base body, is at least partially pushed on the fastening element and is driven in the borehole together with the fastening element. Because for cleaning of the borehole wall, the anchoring element need not be rotatably driven in the borehole but rather should be pushed only axially in the direction of the longitudinal axis of the borehole, no fixing of the anchoring element on the fastening element, in particular, for insuring a joint rotation of the anchoring and fastening elements, is necessary.

During driving of the anchoring element in the borehole, the cleaning side, which is located opposite the connection side, pivots in the direction of the borehole mouth, whereby the at least one edge of the cleaning side brushes along the borehole wall as a cleaning edge, cleaning the wall. In addition to a linear contour, the cleaning edge also has a bent, convex contour projecting, with respect to the sleeve-shaped body, radially outwardly. The convex contour of the cleaning edge advantageously has a curvature approximately corresponding to the inner radius of the borehole, enabling an advantageous cleaning of the borehole wall.

Advantageously, the inventive anchoring element is formed of metal, preferably, sheet metal, whereby the anchoring element has a sufficient stiffness. A simple and economical manufacturing of the inventive anchoring element can be insured by a stamping/bending process.

Advantageously, the sleeve-shaped base body is produced from a flat material, and the anchoring elements are formed with a stamping tool, and then are bent outwardly. An advantageously used stamping tool has at least one cutter less than the number of sides of the anchoring sections. Thereby, the non-stamped side of an anchoring section forms the connection side and the bending edge.

According to an alternative embodiment, the anchoring element is formed of a plastic material, preferably of a fiber-reinforced plastic material. In this case, a simple and economical manufacturing of the anchoring element is insured with an injection-molding process.

Alternatively, the anchoring element can be produced from a material other than metal or plastic material as long as the used material insures a sufficient mechanical anchoring of a fastening element in a borehole until hardening of the hardenable mass.

Advantageously, the sleeve-shaped base body has a cross-sectional shape corresponding to the shaft of the fastening element and, thus, can have a shape deviating from a circle. Advantageously, the sleeve-shaped base body concentrically surrounds the shaft in the mounted condition of the anchoring element, and is circumferentially spaced from the shaft. Thereby, the hardenable mass can penetrate into the space between the shaft of the fastening element and the anchoring element. According to an alternative embodiment, the sleeve-shaped base body surrounds the shaft, being spaced at different distances therefrom, so that the width of the material section between the outer side of the shaft and the inner wall of the sleeve-shaped base body varies.

The anchoring sections of the anchoring element are advantageously arranged relative to each other at a uniform distance from each other both in axial and circumferential directions. Advantageously, the anchoring sections are arranged along a helical line extending along an inner contour or the outer contour of the sleeve-shaped base body. This arrangement of anchoring sections insures an adequate anchoring of the anchoring element over an entire axial extent of the anchoring element in the set condition of the fastening element until the hardenable mass is sufficiently hardened for a complete loading of the set fastening element.

Advantageously, each of the anchoring sections has an even number of sides so that always one of the sides of the anchoring sections forms a cleaning side with a cleaning edge that brushes along the borehole wall.

Advantageously, the through-opening of the base body is at least partially closed in a region of one end of the base body, whereby this end forms a stop of the shaft of the fastening element. Thereby, during driving of the fastening element in the borehole, the anchoring element is entrained by the fastening element up to a desired depth.

Advantageously, the sleeve-shaped base body is formed of at least two parts connectable with each other to form the base body.

With the sleeve-shaped base body being formed of at least two parts, the anchoring element can easily be mounted on any portion of the fastening element shaft. In particular, with a relatively long fastening element, the anchoring element need not be pushed along a large axial length over the shaft when being mounted on a fastening element.

Instead of two, e.g., half-shell-shaped parts, the base body of the inventive anchoring element can be formed of three and more parts which, dependent on their design, can be assembled axially and/or radially to form the base body.

Advantageously, the at least two parts of a multi-part base body are connected with each other by at least one articulation element. The articulation element or hinge prevents the parts of the base body from being lost and insures a simple connection of the parts for forming the sleeve-shaped base body.

Advantageously, the at least one articulation element is provided in the axial end region of the at least two parts of the base body so that the sleeve-shaped base body is formed by pivotal movement of the two parts toward each other.

Preferably, the base body is formed of two parts which are advantageously formed as half-shells and are connected by two located opposite each other articulation elements provided in an axial end region of the two parts. The fastening element is inserted through the opening formed by the two parts.

After the anchoring element occupies its predetermined position on the fastening element, the two parts are pivoted toward each other so that the two parts, e.g., engage the shaft.

According to an alternative embodiment, the at least one articulation element is advantageously provided on axially adjacent to each other, longitudinal sides of the two parts of the base body. This insures an easy mounting of the anchoring element around the shaft at a desired location. For forming the sleeve-shaped base body, the two parts are pivoted toward each other or folded toward each other. Advantageously, the two parts are formed as half-shells.

Alternatively, there is provided at least one locking element for connecting the two parts for forming the sleeve-shaped base body, so that the assembled parts are not inadvertently open during setting of the fastening element. The locking element is advantageously formed as a snap element that includes, e.g., a locking member provided on one of the two parts and a counter-locking member provided on another of the two parts.

Advantageously, the sleeve-shaped base body has at least one through-opening for the hardenable mass. Thereby, during insertion of the anchoring element in a borehole which has already been filled with the hardenable mass, a displaced portion of the hardenable mass easily penetrates into anchoring element that can be, thus, completely enveloped by the hardenable mass. When the borehole is filled with the hardenable mass after the fastening element has been driven in, the poured mass can flow through the at least one through-opening unhindered up to the borehole bottom, to the shaft of the fastening element, and to the borehole wall.

Preferably, the cleaning side, e.g., the outer circumference of the anchoring sections of the anchoring element is provided with a profile that insures an easy adaptation of the anchoring element to the contour of the borehole. E.g., the profile can be formed by recesses which open radially outwardly. The recesses advantageously are formed as slots limited at one side and extending from the cleaning side or the outer circumference in a direction toward the base body. The sections of the anchoring element, which are located between the recesses, form easily deflectable lamellas. This insures adaptation of the anchoring sections to a borehole profile during the insertion of the anchoring element even when the anchoring element is formed of a very stiff material. Advantageously, different types of recesses are provided on the cleaning side of the anchoring element. E.g., one type is represented by slots which form displaceable lamellas on the cleaning side. Between the slots, there is provided a second type of slots which additionally fan out the edge of the anchoring element located therebetween. Further, the profile can be formed by at least one, opening radially outwardly, notch that is provided on the cleaning side of the anchoring section.

Advantageously, the thickness of the anchoring sections corresponds to the wall thickness of the sleeve-shaped base body. For an advantageous anchoring of the anchoring sections on the wall of the borehole, the thickness of the anchoring sections amounts advantageously to from 0.01 mm to 2 mm, preferably, from 0.05 mm to 1 mm. Thus, the sleeve-shaped base body advantageously has, likewise, a wall thickness, advantageously in a range from 0.01 mm to 2 mm, preferably, from 0.05 mm to 1 mm.

Further, advantageously, the anchoring sections have, in a plane projecting from the longitudinal axis of the base body, different thicknesses, which insures that the deformation behavior of the anchoring sections and, thus, of the anchoring element can be advantageously adapted to the profile of the borehole, in particular, during driving of the fastening element with the mounted thereon, anchoring element in the borehole. In a particular advantageous embodiment, these thicknesses increase radially outwardly starting from the base body, or in a direction of the cleaning side. Thereby, an advantageously large amount of material for mechanical anchoring of the fastening element is available in a contact region of the anchoring element with the borehole wall. According to another advantageous embodiment of the present invention, the thickness increases from the cleaning side in the radial direction toward the base body. In this way, an advantageously large amount of material is available in the connection region of the anchoring sections with the base body. Further, the thickness of the anchoring sections can increase from the base body radially outwardly, on one hand, and from the cleaning side in the radial direction toward the base body, on other side. In this way, the region of an anchoring section with a largest material thickness is located between the cleaning side and the base body.

Advantageously, for mounting the anchoring element on the shaft of the fastening element provided with an outer profile, the anchoring element includes a plurality of spaced from each other retaining sections projecting radially inwardly from the base body for securing the base body on the shaft. The retaining sections provide for spacing of the anchoring element from the shaft of the fastening element, and, if necessary, provide for a better attachment of the anchoring element to the shaft.

The sleeve-shaped base body advantageously has a cross-section corresponding to the circumference of the shaft of the fastening element and can, thus, have a contour that deviates from a circle. The retaining sections provide space between the outer side of the shaft and the inner side of the base body and into which the hardenable mass can penetrate, so that upon hardening of the hardenable mass, an advantageous embedding of the anchoring element is insured. Advantageously, the sleeve-shaped base body surrounds the shaft cocentrically in the mounted condition of the anchoring element on the shaft, and is spaced from the shaft. According to an alternative embodiment of the present invention, the base body surrounds the shaft at different distances therefrom, so that the width of the material section between the outer side of the shaft and the inner wall of the sleeve-shaped base body varies in the circumferential direction.

According to an advantageous embodiment, the anchoring element is formed of a non-conductive material. In applications where no current should be conducted, e.g., at attachment of railroad ties, the anchoring element insures, due to the projecting inwardly, retaining sections, a sufficient distance between the shaft and the borehole wall and prevents current flow from a constructional component in the shaft of the fastening element.

Because the retaining sections of the anchoring element do not hinder the mounting process at the beginning, the anchoring element can be easily pushed along the shaft and, thus, easily positioned thereon.

The embodiment of an anchoring element with retaining section is particularly advantageous for fastening elements with a shaft having an outer profile. This is because in the mounted condition of the anchoring element on the shaft, the inwardly projecting retaining sections at least partially engage in the shaft outer profile, securing the anchoring element on the shaft. Because the retaining sections do not, advantageously, extend over the entire circumference of the shaft, the pitch of the shaft outer profile can be balanced, so that the anchoring element is aligned, in its mounted position on the shaft, substantially parallel to the longitudinal axis of the shaft. The adjustment of the fastening element having an anchoring element after setting of the fastening element in a borehole becomes unnecessary in most cases or can be easily carried out, if needed.

Advantageously, the retaining sections are arranged at uniform distances both in axial and circumferential direction relative to each other. Advantageously, the retaining sections are arranged along a helical line extending along the inner contour or the outer contour of the sleeve-shaped base body. This arrangement of the retaining sections insures spacing of the base body from the shaft over the entire extension of the anchoring element in the mounted condition of the anchoring element on the shaft. In addition, this arrangement insures anchoring of the anchoring element over its entire axial extent which, in turn, insures a sufficient anchoring of the fastening element in the borehole in the set condition of the fastening element until the hardenable mass is sufficiently hardened for a full loading of the fastening element.

It is particularly advantageous when the retaining sections are offset relative to the anchoring sections of the anchoring element in both axial and circumferential directions.

When the sleeve-shaped base body is formed of a flat material, e.g., of strip steel, the retaining sections and the anchoring sections advantageously are formed in the flat material with a stamping tool and then finally are bent inwardly. A suitable stamping tool has at least one cutter less than the number of sides of the retaining sections so that the non-stamped side of each retaining section forms a connection side, which connects a respective retaining section with the base body, and the bending edge. The side of each retaining section located opposite the connection section forms a bearing side of the retaining section that at least contacts the outer surface of the shaft in the mounted condition of the anchoring element on the shaft of the fastening element. When the anchoring element is mounted on a fastening element the shaft of which has an outer profile, the bearing sides of the retaining sections engage in the outer profile.

Advantageously, the bearing side or the inner circumference of the anchoring sections of the anchoring element is provided with a profile that insures an easy adaptation of the anchoring element to the contour of the shaft. E.g., the profile can be formed by recesses which open radially inwardly. The recesses advantageously are formed as slots limited at one side and extending from the bearing side or the inner circumference in a direction toward the base body. The sections of the retaining sections, which are located between the recesses, form easily deflectable lamellas. This insures adaptation of the anchoring element to a shaft profile upon mounting of the anchoring element on a fastening element even when the anchoring element is formed of a very stiff material. Advantageously, different types of recesses are provided on the bearing side of the anchoring element. E.g., one type is represented by slots which form displaceable lamellas on the bearing side. Between the slots, there is provided a second type of slots which additionally fan out the edge of the anchoring element located therebetween. Further, the profile can be formed by at least one, opening radially inwardly, notch that is provided on the bearing side of a retaining section.

Advantageously, the thickness of the retaining sections corresponds to the wall thickness of the sleeve-shaped base body. For an advantageous securing of the retaining sections on the shaft, the thickness of the retaining sections amounts advantageously to from 0.01 mm to 2 mm, preferably, from 0.05 mm to 1 mm.

Further, advantageously, the retaining sections have, in a plane projecting from the longitudinal axis of the base body, different thicknesses, which insures that the deformation behavior of the retaining sections and, thus, of the anchoring element can be advantageously adapted to the profile of the shaft, in particular, during driving of the fastening element with the mounted thereon, anchoring member in the borehole. In a particular advantageous embodiment, these thicknesses increase radially inwardly starting from the base body, or in a direction of the bearing side. Thereby, an advantageously large amount of material for mechanical connection of the anchoring element with the shaft is available in a contact region of the anchoring element with the shaft. According to another advantageous embodiment of the present invention, the thickness increases from the bearing side in the radial direction toward the base body. Further, the thickness of the retaining sections can increase from the base body radially inwardly, on one hand, and from the bearing side in the radial direction toward the base body, on other hand. In this way, the region of a retaining section with a largest material thickness is located between the bearing side and the base body.

According to one embodiment of the invention, alternatively to formation of a one-piece anchoring element, the retaining sections and/or anchoring sections are formed as separate elements that are subsequently arranged on the inner wall or the outer wall, respectively, of the sleeve-shaped base body.

An inventive fastening assembly, which is anchorable in a borehole with a hardenable mass, includes a fastening element having a shaft and at least one anchoring element as described above. The at least one anchoring element can have separate or all of the features of the described anchoring element.

The inventive fastening assembly can be easily produced and enables its easy setting in a borehole of a constructional component, e.g., in a wall or a ceiling. The outer profile of the shaft is, e.g., a thread.

Advantageously, a plurality of anchoring elements are mounted on a shaft of a fastening element at a distance from each other. Thereby, an advantageous anchoring of a fastening element in a borehole and an advantageous reinforcement of the hardened mass is insured. Advantageously, the anchoring elements are mounted on the shaft at a uniform distance from each other.

Advantageously, different types of anchoring elements are provided on the shaft, which permits to combine, if necessary, different anchoring characteristics at different anchoring depth. E.g., sleeve-shaped anchoring elements can be combined, on a shaft of a fastening element, with flat ring-shaped or screw-shaped anchoring elements.

An inventive fastening arrangement for anchoring a fastening assembly with a hardenable mass in a borehole having a nominal diameter, includes a fastening element having a shaft and at least one anchoring element mounted on the shaft and having an outer diameter greater than nominal diameter of the borehole.

During driving of the fastening element or the fastening assembly in a borehole, simultaneously, cleaning of the borehole is carried out as a result of brushing of the anchoring sections of the anchoring element along the borehole wall. As a result, drillings, which are produced during drilling of the borehole, are accumulated at the borehole bottom and, if required, are accumulated in the hardenable mass, and are not released anymore in a large amount into environment. A separate cleaning of the borehole before setting of the fastening element is not any more necessary, despite of which high end loads with the anchored fastening element or fastening assembly are achieved. Further, the at least one anchoring element provides for protection against splash of the hardenable mass during driving of the fastening assembly in the borehole.

With the elimination of the cleaning step, the reliability is increased, and the setting of the fastening element or the fastening assembly is accelerated. No additional devices are necessary, and the surrounding air is not contaminated by drillings. Further, a sufficient covering of the shaft of the fastening element along its entire anchoring length with a hardenable mass is insured with a correspondingly positioned anchoring element or elements.

The at least one anchoring element, or fastening element, or the fastening assembly can have separate or all features of the above-described anchoring element, fastening element, and the fastening assembly.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional plan view of a first embodiment of an anchoring element according to the present invention;

FIG. 2 a side view of the anchoring element shown in FIG. 1;

FIG. 3 a side view of a second embodiment of an anchoring element according to the present invention;

FIG. 4 a cross-sectional view of the anchoring element shown in FIG. 2;

FIG. 5 a cross-sectional plan view of a third embodiment of an anchoring element according to the present invention;

FIG. 6 a side view of a fourth embodiment of an anchoring element according to the present invention;

FIG. 7 a side view of a fifth embodiment of an anchoring element according to the present invention; and

FIG. 8 a cross-sectional view of a fastening arrangement according to the present invention with an inventive fastening element.

Basically, in the figures, the same element are designated with the same reference numerals.

### DETAILED DESCRIPTION OF THE PREFERRED EMBODIMENTS

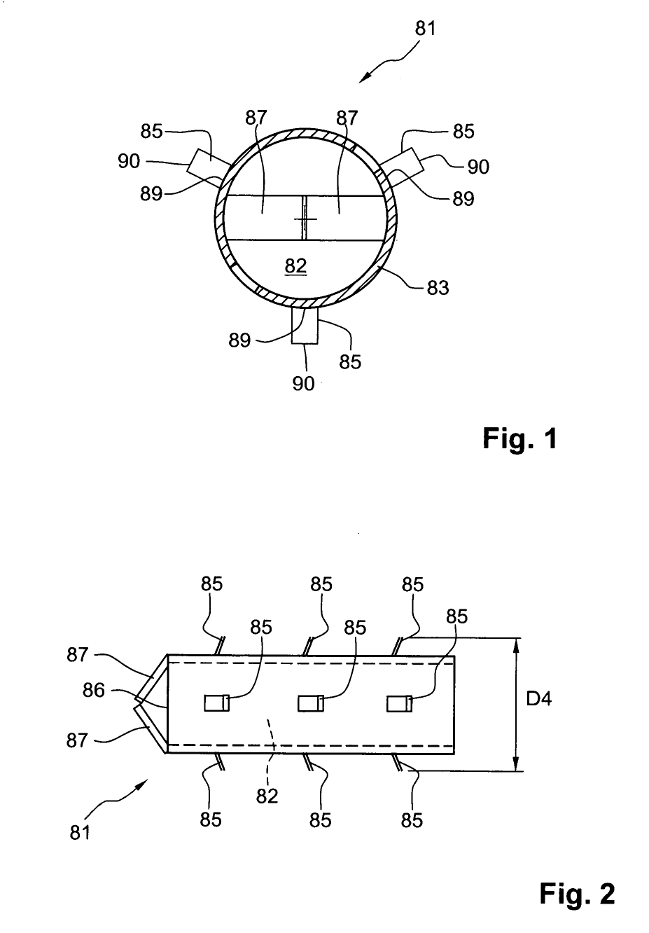

An anchoring element 81 according to the present invention, which is shown in FIGS. 1 and 2, has a through-opening 82 for a shaft of a fastening element. The through-opening 82 is surrounded by a base body 83. In a region of an end 86 of the base body 83, there are provided material sections 87 which project radially inwardly for a partial closing of the through-opening 82 in the region of the end 86.

The sleeve-shaped base body 83 has a plurality of spaced from each other, anchoring sections 85 extending radially outwardly for being anchored on a wall of a borehole. Each anchoring section 85 has the same number of sides, four in the embodiment shown in FIGS. 1-2. One of the sides of the anchoring section 85 forms a connection side 89 connected with the base body 83. The side of the anchoring section 85 opposite the connection side 89 forms a cleaning side 90 of the anchoring section 85. The cleaning sides 90 of the anchoring sections 85 each has at least one cleaning edge for cleaning the wall of the borehole upon the anchoring element 81 being driven in the borehole.

The anchoring element 81 has an outer diameter D4 and is formed of metal, preferably, sheet metal, by a stamping and bending process.

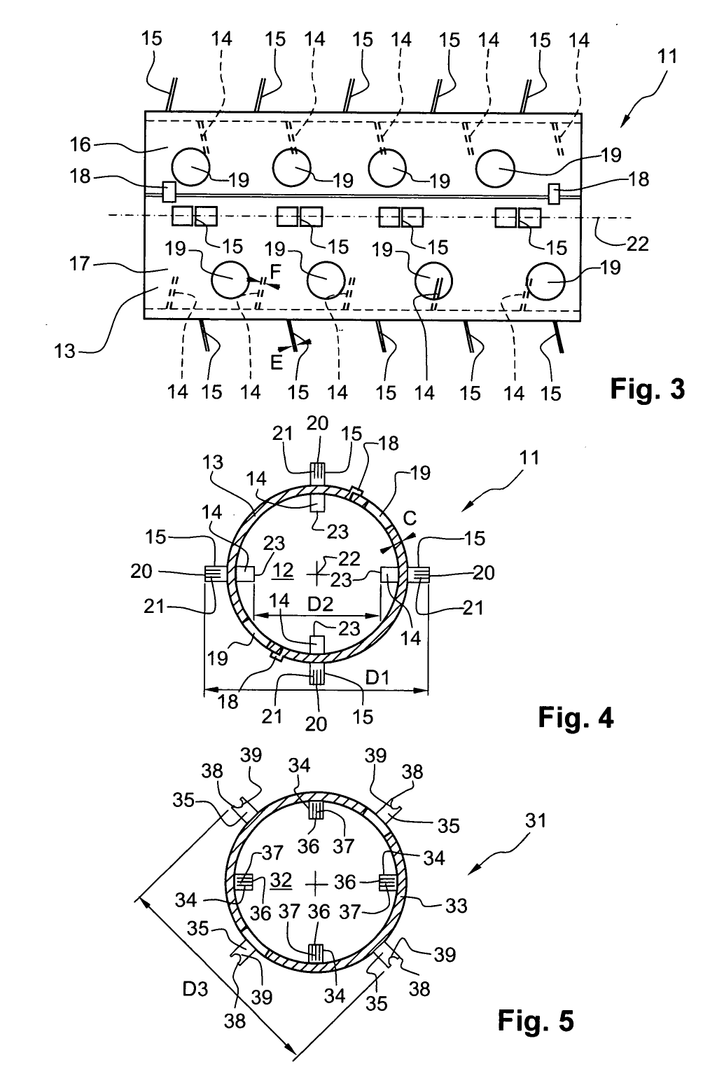

The sleeve-shaped base body 13 of the anchoring element 11, which is shown in FIGS. 3-4, has, as against the anchoring element 81, two parts 16 and 17 connected by two, located opposite each other, locking elements 18 to form the sleeve-shaped body 13. The locking elements 18 are formed as snap connection elements.

The sleeve-shaped base body 13 has a plurality of spaced from each other, retaining sections 14 projecting radially inwardly for securing the base body 13 on an outer side, e.g., an outer profile of a shaft of a fastening element, and has a plurality of spaced from each other, anchoring sections 15 projecting radially outwardly for anchoring the base body 13 on the wall of the borehole. The base body 13 further has a plurality of through-openings 19 for a hardenable mass.

The cleaning side 20, e.g., the outer circumference of the anchoring sections 15 is provided with a profile in form of a plurality of extending radially inwardly slots 21 which proceed from the cleaning side 20. The slots 21 at least partially fan out the free edges of respective anchoring sections 15, insuring their easy adaptation to the wall of the borehole. The anchoring element 11 has an outer diameter D1 and different thicknesses in a plane projecting from a longitudinal axis 22 of the base body 13. In the embodiment shown in FIGS. 3-4, the thickness E increases, proceeding from the base body 13 outwardly in the radial direction, e.g., towards the cleaning side 20.

The retaining sections 14 likewise have different thicknesses in the plane projecting from the longitudinal axis 22 of the base body 13. In the embodiment shown in FIGS. 3-4, the thickness F increases, proceeding from the base body 13, inwardly in the radial direction, e.g., toward a bearing side 23. The radial distance D2 of two retaining sections 14 relative to each other is smaller than the diameter of the fastening element shaft on which the anchoring element 11 is secured.

The anchoring element 11 is formed of metal, preferably, sheet metal by a stamping and bending process.

The anchoring element 31, which is shown in FIG. 5, likewise has a through-opening 32 for a shaft of a fastening element and which is surrounded by a sleeve-shaped base body 33. The base body 33 has a plurality of spaced from each other, retaining section 34 projecting radially inwardly, and a plurality of spaced from each other anchoring sections 35 projecting radially outwardly. On the cleaning side 38, e.g., an outer circumference of the anchoring sections 35, there is provided, respectively, a notch 39 forming an outer profile of a respective anchoring section 35. For forming easily deflectable lamellas, e.g., a profile on a bearing side, e.g., on the inner circumference of the retaining sections 14, there are provided a plurality of slots 37 extending radially inwardly from the bearing side 34. The slots 37 at least partially fan out the free edges of the retaining sections 34, insuring an easy adaptation of the retaining sections 34 to the shaft of the fastening element. The anchoring element 31 has an outer diameter D3.

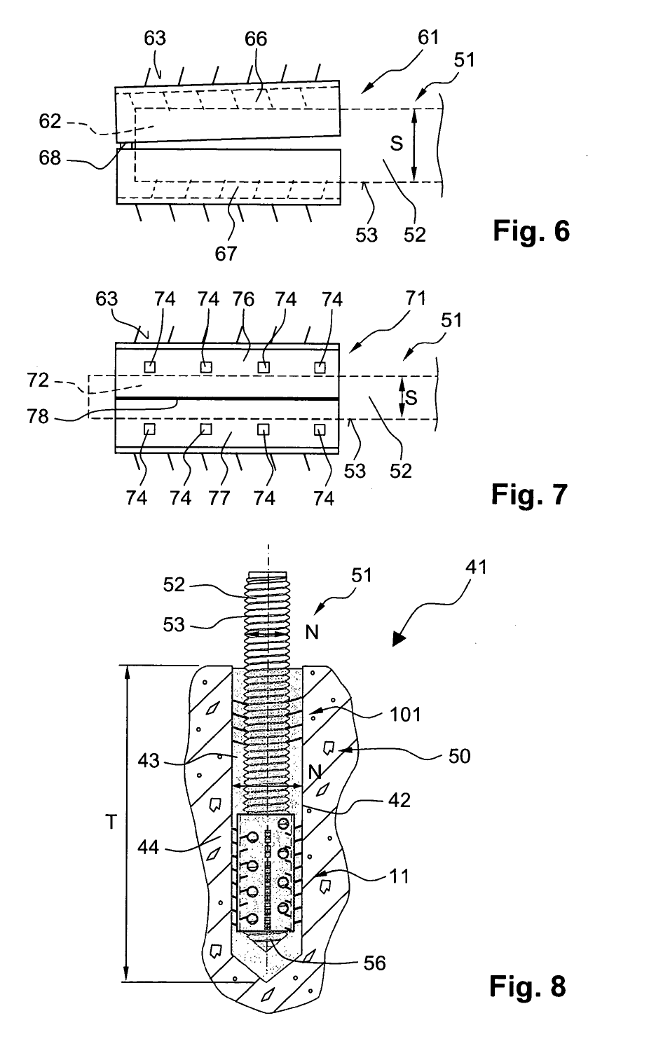

An anchoring element 61, which is shown in FIG. 6, is formed of two parts 66 and 67 connected with each other by an articulation element 68, which is provided in one axial end region of the parts 66 and 67, to form a sleeve-shaped base body 63. The articulation element 68 provides for a pivotal movement of the parts 66 and 67 relative to each other.

An anchoring element 71, which is shown in FIG. 7, is formed of two half-shells 76 and 77 connected by an articulation element 78, which is provided on one of the opposite axial longitudinal sides of the half-shells 76 and 77, to form a sleeve-shaped base body 73. The articulation element 78 provides for a pivotal movement of the two half-shells 76 and 77 relative to each other. The retaining sections 74, which are provided on the half-shells 76 and 77, engage in the outer profile 53 of the shaft 52 of the fastening element 51 only after the half-shells 76 and 77 have been connected with each other to form the sleeve-shaped base body 73.

FIG. 8 shows a fastening arrangement 41 for anchoring a fastening assembly 50 in a borehole 42 with a hardenable mass 43.

The fastening assembly 50 includes a fastening element 51 having a shaft 52 with an outer thread that forms an outer profile 53, and two types of anchoring elements 11 and 101 arranged on the shaft 52. The shaft 52 has an outer diameter S (please see FIG. 6). The anchoring elements are formed as annular disc-shaped elements which are arranged on the shaft 52 at a uniform distance from each other. The anchoring element 11 with a sleeve-shaped base body 13 is arranged on a setting direction end 56 of the shaft 52. Instead of different anchoring elements 11 and 101, a plurality of the same, e.g., anchoring elements 11 can be provided on the shaft 52 of the fastening element 51. This insures a reliable adaptation of the anchoring element 51 to site conditions when the anchoring element 11 is arranged on the shaft 52, the retaining sections 14 are deflected. The retaining sections 14 engage with their free ends in the outer profile 53 provided on the shaft 52, securing the anchoring element 11 on the shaft 52 of the fastening element 51. The anchoring elements 11 and 101 can be pushed onto the shaft 52 or screwed thereon.

Instead of different anchoring elements 11 and 101, a plurality of anchoring elements of the same type can be provided on a shaft of a fastening element. Dependent on the requirements to a set fastening element should meet, only one anchoring element can be provided on a shaft of a fastening element.

For setting the fastening assembly 50 or the fastening element 51 in a constructional component 44, firstly, a borehole 42 is formed with a drill, with the nominal diameter N of the produced borehole 42 being selected so that it is smaller than the outer diameter D1 of the anchoring element 11 and smaller than the outer diameter of the anchoring element 101. The depth T of the borehole 42 is determined, on one hand, by the necessary anchoring length for the fastening element 51 and, on the other hand, by a space in front of the fastening element 51 for receiving the drillings produced during drilling of the borehole 42.

Finally, the borehole 42 is filled with a predetermined amount of the mass 43, and the fastening element 51 is driven in the borehole 42 with the setting direction-side end 56 first. The driving of the fastening element 51 in the borehole 42 can be effected manually or mechanically. As the fastening element 51 is driven in the bore 42, the anchoring sections 15 of the anchoring element 11, which is arranged on the shaft 52 of the fastening element 51 brush along the borehole wall, whereby a major part of the drillings, which are bonded to the wall, are removed from the wall, and become intermixed with the mass 43 or are displaced to a borehole bottom.

During insertion of the fastening element 51 in the borehole 42, the hardenable mass 43 flows through and around the anchoring element 11 through the through-openings 19 in the sleeve-shaped base body 13. Thereby, the hardenable mass 43 and the drillings located therein uniformly intermix, and the anchoring element 11 becomes completely embedded in the hardenable mass 43 after the mass 43 has been hardened.

Alternatively, firstly, the fastening element 51 is driven in the borehole 42 and than the hardenable mass 43 is poured into the borehole 42. According to another alternative embodiment, firstly, a small, predetermined amount of the hardenable mass 43 is poured into the borehole, then the fastening element 51 is driven in the borehole 42 and, finally, the remaining free space of the borehole 42 is filled with a further amount of the hardenable mass 43.

The shaft 52 of the fastening element 51 can also be provided with an injection bore through which the hardenable mass 43 is brought into the borehole 42 after the fastening element 51 was driven in or during the driving of the fastening element 51 in the borehole 42.

Even before the hardenable mass 43 hardens, the fastening element 51 can be loaded to a certain limited level because at least the anchoring element 11 mechanically anchors the fastening element 51 in the borehole 42. After the hardenable mass 43 hardens, the set fastening element 57 can be loaded to a maximum allowable level.

Because the cleaning side 20 of the anchoring sections 15 engage in the borehole wall at least in some regions, an adequate contact surface is available, which permits to use the fastening element 51 in a crushed concrete.

Because the anchoring sections 15 and the retaining sections 14 are completely surrounded by the hardenable mass 43 in a set condition of the fastening element 51, even at small thicknesses E of the anchoring sections 15 of the base body 13 or small thicknesses F of the retaining sections 14, the blow-up of these sections under a load is prevented already before a complete hardening of the hardenable mass 43.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. An anchoring element (11; 31; 61; 71; 81) for being mounted on a shaft (52) of a fastening element (51), the anchoring element comprising a sleeve-shaped base body (13; 33; 63; 73; 83) forming a through-opening (12; 32; 62; 72; 82) for the shaft (52); and anchoring sections (15; 35; 85) projecting outwardly from an outer side of the base body (13) for anchoring on a wall of a borehole (42), each of the anchoring sections (15; 35; 85) having at least four sides, with one of the sides forming a connection side (89) for connecting a respective anchoring section (15; 35, 85) with the base body (13; 33; 63; 73; 83) and with at least a side located opposite the connection side (89) forming a cleaning side (90) of the respective anchoring section (15; 35; 85), the cleaning side (90) having at least one cleaning edge for cleaning the wall of the borehole (42) during driving of the anchoring element (11; 31; 61; 71; 81) in the borehole (42).

2. An anchoring element according to claim 1, wherein each of the anchoring sections (15; 35; 85) has an even number of sides.

3. An anchoring element according to claim 1, wherein the through-opening (82) is at least partially closed in a region of one end (86) of the base body (83).

4. An anchoring element according to claim 1, wherein the sleeve-shaped base body (13; 63; 73) is formed of at least two parts (16, 17; 66; 67; 76; 77) connectable with each other to form the base body (13; 63; 73).

5. An anchoring element according to claim 1, wherein the sleeve-shaped base body (13) has at least one through-opening (19) for a hardenable mass (43).

6. An anchoring element according to claim 1, wherein one cleaning side (20; 38; 90) of the anchoring sections (15; 35; 85) is provided with a profile.

7. An anchoring element according to claim 1, wherein for mounting the anchoring element on the shaft (52) of the fastening element (51) provided with an outer profile (53), the anchoring element further comprise a plurality of spaced from each other retaining sections (14; 34) projecting radially inward from the base body (13) for securing the base body (13) on the outer profile (53) of the shaft (52).

8. An anchoring element according to claim 7, wherein a bearing side (36) of the retaining sections (34) is provided with a shaped profile.

9. A fastening assembly for being anchored in a borehole (42) with a hardenable mass (43), the fastening assembly comprising a fastening element (57) having a shaft (52); and an anchoring element (11; 31; 61; 71; 81) for being mounted on a shaft (52) of a fastening element (51) and including a sleeve-shaped base body (13; 33; 63; 73; 83) forming a through-opening (12; 32; 62; 72; 82) for the shaft (52) and anchoring sections (15; 35; 85) projecting outwardly from an outer side of the base body (13) for anchoring on a wall of a borehole (42), each of the anchoring sections (15; 35; 85) having at least four sides, with one of the sides forming a connecting side (89) for connecting a respective anchoring section (15; 35; 85) with the base body (13; 33; 63; 73; 83) and with at least a side located opposite the connection side (89) forming a cleaning side (90) of the respective anchoring section (15; 35; 85), the cleaning side (90) having at least one cleaning edge for cleaning the wall of the borehole (42) during driving of the anchoring element 911; 31; 61; 71; 81) in the borehole (42).

10. A fastening assembly according to claim 9, wherein a plurality of anchoring elements (11, 101) are mounted on the shaft (52) of the fastening element (51) at a distance from each other.

11. A fastening assembly according to claim 10, wherein the plurality of anchoring elements (11, 101) consists of different types of anchoring elements (11, 101).

12. A fastening arrangement for anchoring, in a borehole (42) having a nominal diameter (N), a fastening assembly with a hardenable mass (43), the fastening assembly including a fastening element (51) having a shaft (52) and an anchoring element (11; 31; 61; 71; 81) for being mounted on a shaft (52) of a fastening element (51), the anchoring element having an outer diameter (D1) greater than the nominal diameter (N) of the borehole (42) and including a sleeve-shaped base body (13; 33; 63; 73; 83) forming a through-opening (12; 32; 62; 72; 82) for the shaft (52) and anchoring sections (15; 35; 85) projecting outwardly from an outer side of the base body (13) for anchoring on a wall of a borehole (42), each of the anchoring sections (15; 35; 85) having at least four sides, with one of the sides forming a connection side (89) for connection a respective anchoring section (15; 35; 85) with the base body (13; 33; 63; 73; 83) and with at least a side located opposite the connection side (89) forming a cleaning side (90) of the respective anchoring section (15; 35; 85), the cleaning side (90) having at least one cleaning edge for cleaning the wall of the borehole (42) during driving of the anchoring element (11; 31; 61; 71; 81) in the borehole (42).
